(19) United States
(12) Patent Application Publication
(10) Pub. No.: US 2007/0101196 A1
(43) Pub. Date: May 3, 2007

(54) Functional testing and verification of software application

(76) Inventors: William Arthur Rogers, Austin, TX (US); Joseph Barta, Austin, TX (US)

Correspondence Address: FULBRIGHT & JAWORSKI L.L.P., 600 CONGRESS AVE., SUITE 2400, AUSTIN, TX, 78701, US

(21) Appl. No.: 11/264,416

(22) Filed: Nov. 1, 2005

(51) Int. Cl. G06F 11/00

(52) U.S. Cl. 714/38

(57) ABSTRACT

The present disclosure provides methods for testing a software application using the natural input flow of the application. In one respect, a method includes observing the software application under test to determine a current, active input site of the application. The method generates a stimulus for the current, active input site based on the current execution state of the application and applies the stimulus to the current, active input site. The response of the stimulus may be evaluated. In one respect, the response may be evaluated prior to and after the stimulus is applied.

### BACKGROUND OF THE INVENTION

1. Field of the Invention

The present invention relates generally to software application testing. In particular, the present invention involves testing software using a natural input focus sequence of the software.

2. Description of Related Art

Software testing is generally performed to determine and correct defects in the software before placing the software in production or releasing the software for public use. Conventional testing includes scripting, generally written in a programming language such as Visual Basic, JavaScript, or Perl. Scripting allows a user to express a test as a sequence of programmed steps that controls the software under test. In particular, the programmed steps direct how the software is tested and what part of the software gets tested. The script attempts to force the software to perform a specific task, generally in a sequence not normal to the general operations of the software. For example, the script attempts to test certain aspects of the software; however, scripting does not account for updates to the software occurring at runtime, and thus, may not thoroughly verify the functionality of the software. Additionally, changes to the software may require updates to the software, and thus is inefficient.

Scripting may allow for checks to be embedded in the scripts to verify the correct or incorrect operation of the software. However, if a user has a plurality of scripts that exercise a particular subsection of the application, and the user wants to verify the software when a particular place in that subsection is accessed, the user will have to insert the check into the right place in many if not all of the scripts used. Also, checking can only be performed during the execution of the sequences provided by the user.

Another example of conventional software testing is based on a table driven technique, where a user specifies a sequence of steps in a tabular form. These tables typically specify an interaction point, e.g., a point in the software where data or a stimulus may be provided. The table can also provide the data or stimulus. Upon receiving an outcome, optional actions may be performed. Although the user is not expressing the test in a programming language, the test still represents a set of steps to be asserted on the software with the expectation that the software will follow a predetermined set of steps, similar to scripting.

Another example of software testing methods include model based testing, where important functions of the software are modeled as a finite state machine and represented as a directed graph of edges and vertices, where the edges represent input actions and the vertices represent program states. Starting in one state and performing the action specified by an edge takes the model to another state of the edge.

A traversal of the directed graph model of the software represents an analogous sequence of steps in the actual software. A large number of tests which cover many different paths in the software can be generated quickly by well known and ad-hoc graph traversal algorithms. Checking in model-based testing must be bound to the model states. These states are high level abstractions of the actual application state and the level of abstraction makes checking complicated and difficult. For this reason, model-based testing is primarily used to assure the software does not terminate unexpectedly. Model-based testing is similar to scripting, table-driven testing, and keyword-based testing in that the test is an externally provided sequence of steps that is asserted on the software.

Conventional software testing also includes automatic test pattern generation (ATPG) where the software is abstracted to a set of Boolean equations or a Boolean logic diagram. By using a stuck-at fault model and automatic test pattern generation techniques developed for digital integrated circuits, a sequence of input stimuli and output responses is generated. ATPG is similar to model-based testing in that it uses a high-level model of the software as the basis for creating test sequences. It is also similar to the other previously mentioned testing techniques in that the test is an externally provided sequence of steps that is asserted on the software.

Any shortcoming mentioned above is not intended to be exhaustive, but rather is among many that tends to impair the effectiveness of previously known techniques for software testing; however, shortcomings mentioned here are sufficient to demonstrate that the methodologies appearing in the art have not been satisfactory and that a significant need exists for the techniques described and claimed in this disclosure.

### SUMMARY OF THE INVENTION

The present disclosure provides a method for system level functional test and a verification platform that works at the user interface. In one respect, a method for testing a software application is provided. The method may include monitoring the software application during natural execution to determine an active focus site of the software application. The method may generate a stimulus and provide the stimulus for the active focus site. The stimulus may be generated based on a current execution state of the application.

In some respects, the method may include steps for verifying the behavior of the software application before and after providing the stimulus. In particular, the method may first determine the expected response of the software application to the stimulus and may monitor the response of the application to the stimulus to see if it differs from the expected response.

An “active focus site” as described and used in this disclosure refers to an input site of the application to which an operating system will direct input from external sources including, for example, other software, a storage device, a human interaction site, the Internet, a keyboard, a mouse, or the like.

“Focus sites” as described and used in this disclosure are input points of the application.

“Provider” as described and used in this disclosure, refers to an object that generates a stimulus for use in interacting with an application under test (AUT).

“Bindings” as described and used in this disclosure, refer to a connection of a form or document to a behavior or a control to a provider and optionally, at least one rule.

A “template” as described and used in this disclosure, includes a set of configuration files containing a partial configuration intended as a starting point for a testing configuration process.

A “rule”, as described and used in this disclosure, includes the expected state of an application under test (AUT). This may include, for example, the state of the application before and/or after the stimulus is applied. Alternatively, the rule may also include the conditions under which that expectation is applicable. The rule may include optional information to be remembered for future use by this rule or other testing elements, and may also include the outcomes of matching or not matching the expected state of the AUT or the applicable conditions.

Other features and associated advantages will become apparent with reference to the following detailed description of specific embodiments in connection with the accompanying drawings.

### BRIEF DESCRIPTION OF THE DRAWINGS

The following drawings form part of the present specification and are included to further demonstrate certain aspects of the present invention. The figures are examples only. They do not limit the scope of the invention.

FIG. 1 shows a system for testing a software application, in accordance with embodiments of the present disclosure.

FIG. 2 shows a method for testing a software application, in accordance with embodiments of the present disclosure.

FIG. 3 shows a graphical user interface of an application program for logging in, in accordance with embodiments of the present disclosure.

FIG. 4 shows a graphical user interface (GUI) for selecting software development projects to create test configurations, in accordance with embodiments of the present disclosure.

FIG. 5 shows a graphical user interface (GUI) for selecting a template for a project selected in FIG. 4, in accordance to embodiments of the present disclosure, in accordance with embodiments of the present disclosure.

FIG. 6 shows a GUI for editing bindings of behaviors, providers, and rules to elements of the AUT, in accordance with embodiments of the present disclosure.

FIG.7 shows a GUI for editing the settings for a provider, in accordance with embodiments of the present disclosure.

FIG. 8 shows a GUI for editing bindings, where a rule binding is added, in accordance with embodiments of the present disclosure.

FIG. 9 shows a GUI for editing the settings for a rule, in accordance with embodiments of the present disclosure.

FIG. 10 shows a GUI for editing AUT and test run settings, in accordance with embodiments of the present disclosure.

FIG. 11 shows a GUI for editing default bindings, in accordance with embodiments of the present disclosure.

FIG. 12 shows a GUI for editing provider groups, in accordance with embodiments of the present disclosure.

FIG. 13 shows a GUI for editing test sequences, in accordance with embodiments of the present disclosure.

FIG. 14 shows a GUI for editing data sources, in accordance with embodiments of the present disclosure.

FIG. 15 shows a GUI for test execution, in accordance with embodiments of the present disclosure.

FIG. 16 shows a verification report from the tested software application, in accordance with embodiments of the present disclosure.

FIG. 17 shows an example software under test, in accordance with embodiments of the present disclosure.

FIG. 18 shows source code of a configuration binding, in accordance with embodiments of the present disclosure.

FIGS. 19A and 19B show source code of a binding file, in accordance with embodiments of the present disclosure.

FIG. 20 shows source code of a default binding file, in accordance with embodiments of the present disclosure.

FIGS. 21A and 21B show source code for shows source code for a DLL load, in accordance with embodiments of the present disclosure.

FIGS. 22A and 22B show source code for Observers and remap functions, in accordance with embodiments of the present disclosure.

FIG. 23 shows source code for performing a provider lookup, in accordance with embodiments of the present disclosure.

FIG. 24 shows source code for implementing a rule, in accordance with embodiments of the present disclosure.

FIG. 25 shows source code for implementing a provider, in accordance with embodiments of the present disclosure.

### DESCRIPTION OF ILLUSTRATIVE EMBODIMENTS

The disclosure and the various features and advantageous details are explained more fully with reference to the nonlimiting embodiments that are illustrated in the accompanying drawings and detailed in the following description. Descriptions of well known starting materials, processing techniques, components, and equipment are omitted so as not to unnecessarily obscure the invention in detail. It should be understood, however, that the detailed description and the specific examples, while indicating embodiments of the invention, are given by way of illustration only and not by way of limitation. Various substitutions, modifications, additions, and/or rearrangements within the spirit and/or scope of the underlying inventive concept will become apparent to those skilled in the art from this disclosure.

The present disclosure provides for a system level functional test and verification platform that works at the user interface level. In particular, embodiments of the present disclosure provide automatic methods for observing an application under test (e.g., software program) and dynamically respond to the application. The method allows for working with native window and browser-based applications that run under, for example, Microsoft Windows® operating systems and Microsoft Internet Explorer®. The software testing techniques can support users adding customizable interaction and verification elements, configuration templates, reports, and redefine Pass or Fail criteria.

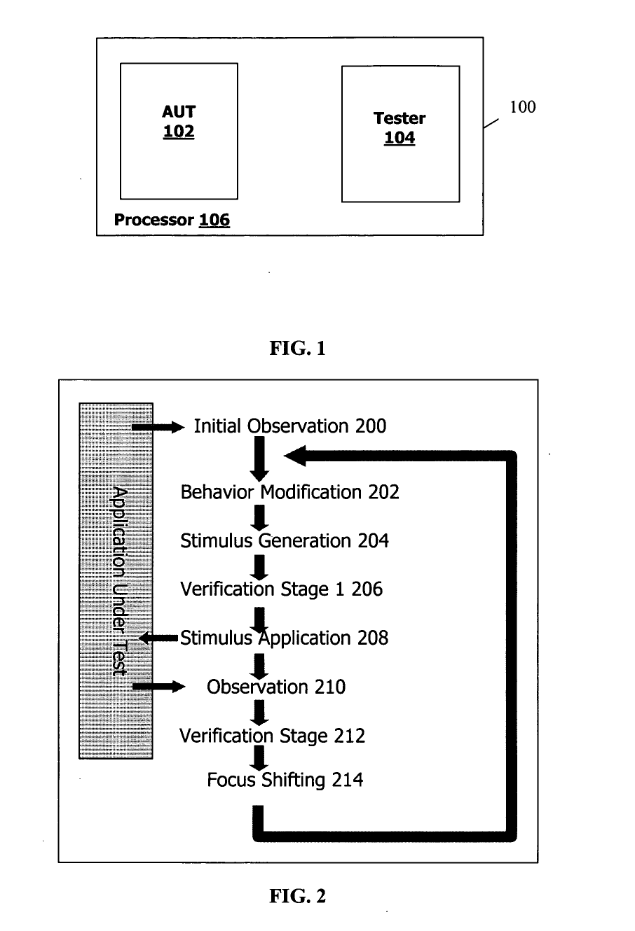

Referring to FIG.1, a system 100 for testing software application is shown. The application under test (AUT) 102 may be tested by, for example, tester 104. The application may include, without limitation, a software program that has a natural interaction flow and simple user interactions (e.g., accounting, purchasing, human resources, customer relationship management, or other data entry centric applications), HTML pages, etc. The AUT may be stored in any computer-readable media known in the art and may be stored, executed, and/or configured by processor 106 For example, AUT 102 may be embodied internally or externally on a hard drive, ASIC, CD drive, DVD drive, tape drive, floppy drive, network drive, flash, or the like. Processor 106 can be any computing device capable of executing instructions, such as, but not limited, to the instructions of the AUT. In one embodiment, processor 106 is a personal computer (e.g., a typical desktop or laptop computer operated by a user). In another embodiment, processor 106 may be a personal digital assistant (PDA) or other handheld computing device.

In some embodiments, tester 104 may execute on networked device, such as processor 106, and may constitute a terminal device running software from a remote server, wired or wirelessly. For example, tester 104 may be used to test AUT 102, which may be at a remote location accessible through a network link. Output, if necessary, may be achieved through one or more known techniques such as an output file, printer, facsimile, e-mail, web-posting, or the like. Storage may be achieved internally and/or externally and may include, for example, a hard drive, CD drive, DVD drive, tape drive, floppy drive, network drive, flash, or the like. Processor 106 may use any type of monitor or screen known in the art, for displaying information, such as test configurations, verification reports, etc. In other embodiments, a traditional display may not be required, and processor 104 may operate through appropriate voice and/or key commands.

In one embodiment, AUT 102 may be stored in a read-only-memory (ROM). Alternatively, AUT 102 may be stored on the hard drive of processor 106, on a different removable type of memory, or in a random-access memory (RAM). AUT 102 may also be stored for example, on a computer file, a software package, a hard drive, a FLASH device, a floppy disk, a tape, a CD-ROM, a DVD, a hole-punched card, an instrument, an ASIC, firmware, a “plug-in” for other software, web-based applications, or any combination of the above.

In one embodiment, tester 104 may model the AUT as a set of interaction elements organized into groupings called forms and/or documents. These forms or documents generally correspond to a visual grouping of elements presented to the user, and as such, the term form and document may be used interchangeable throughout the disclosure. The groupings also generally correspond to the collection of controls placed on a form or dialog by a developer in an application that runs under Microsoft Windows® operating systems or the collection of HTML elements placed in an HTML page or document. These collections of elements can be created statically as the program is created or dynamically as it executes.

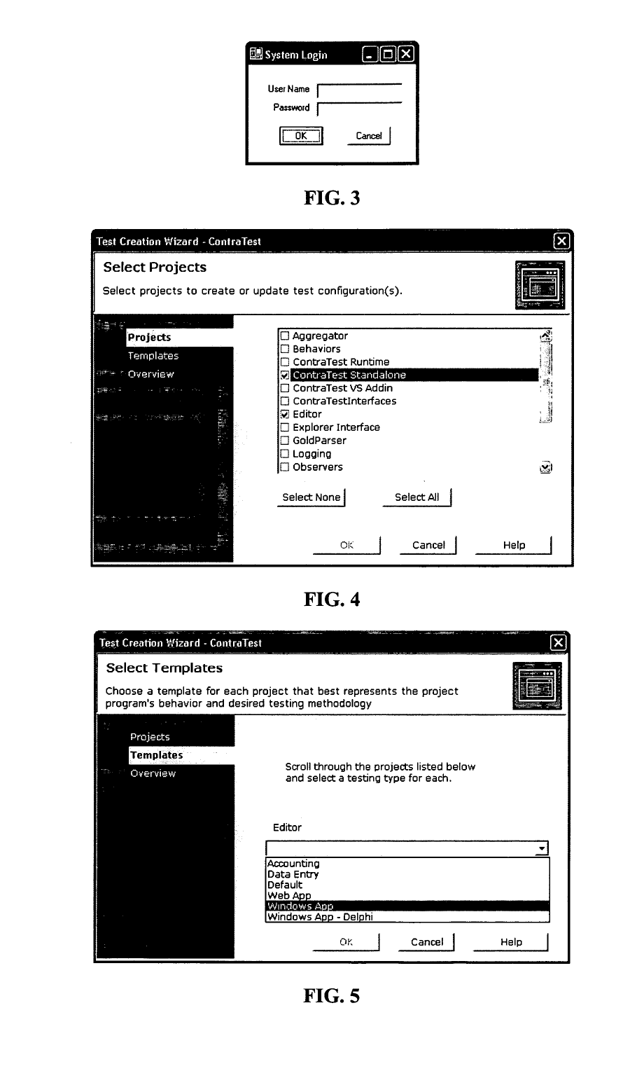

As an AUT executes, the input focus shifts from element to element and document to document. Tester 104 may use objects, called observers to look at the application under test and map the focus sites of the application into the document and/or element model. Focus sites, as noted above, are input points of the application. Being able to uniquely identify each document and element pair allows tester 104 to track the execution of the application. For example, FIG. 3 shows a log-in page which requires a user name and password. In one embodiment, the first focus site may be the user name field, which requires a user to provide identification information. The next focus site may be the password field, which requires the user to provide confirmation information, generally a security code including alpha characters, numeric characters, or alpha-numeric characters. The third focus site may be the OK button which would submit the user name and password to the system for processing and the fourth focus site may be the Cancel button which would abort the log-in. A programmer in developing a login screen like shown in FIG. 3 would generally set the natural focus sequence to the order described because this is the most common, and generally anticipated order a user would expect to interact with these controls. The form is the application element that contains these controls.

In some applications, including traditional HTML pages and native applications the AUT controls and forms may be mapped directly to controls and forms in the tester 104 by the observers, i.e., a 1 to 1 mapping. More complex application implementation techniques may dynamically create or reuse documents and elements, which may require a more complex mapping process. However, most applications provide some form of visual queues that can be used to help identify the document and element with focus. These applications generally reuse a floating text box to capture input for many different input sites. Since each site occurs at a different place on the screen, the position of the floating text box identifies its intended use. For example, many applications display information in a tabular form in a table or grid. In many implementations, the table or grid is not directly interactive. Navigating to a particular item may be accomplished with the arrow keys or mouse, and editing the item occurs in a text box that is superimposed over the background table or grid. Visually, the user appears to be editing data directly in the grid or table. Rather than create a unique text box for each item in the table, the application can create one or just a few text boxes and reuse them by changing their position as needed. As such, the observer may need to differentiate each reuse of the text box so the tester treats editing each item uniquely. In one embodiment, the observer may determine the row and column location of the textbox over the grid and may incorporate a combination of the column name and row number into the returned name, allowing the observer to map a reused text box to many unique identifiers. The reuse and superimposition of controls is a common technique and is used in many different applications, including browsers like Microsoft Internet Explorer.

Other situations can arise where the AUT contains a plurality of uniquely named elements but due to the nature of the application and the testing goals, a plurality of elements should be treated as the same element. In this case, the observer may map many different names to the same name. This situation occurs in automatically generated tables in HTML applications.

In one embodiment, tester 104 may include a test main loop which includes an initial observation (step 200) of an application under test (AUT) during execution as shown in FIG. 2. This step may identify the current focus site of the AUT.

In step 202, tester 104 may perform a behavior modification based on a behavior object. A behavior object maintains a history of the focus sites and makes decisions for altering the focus site based on a current focus site and the execution history of the AUT. This is useful to detect undesired loops or other conditions where the AUT is failing to progress as desired during testing. In one embodiment, tester 104 may know which user interface element is active in the AUT (the focus site) and can choose to proceed with an input, advance to the next focus site, jump to a different focus site, or other behavioral choices. Based on the results of behavior modification some or all of the subsequent steps can be abbreviated, or skipped. The general purpose of behavior modification is to assert control over the natural input flow of the AUT when that flow becomes problematic for testing purposes.

In step 204, a stimulus may be generated. Stimulus generation creates the stimulus that will be applied to the AUT at a later step. In one embodiment, the stimulus may be created by stimulus generation functions called providers. Provider, as described and used in this disclosure, refers to an object that generates a stimulus for use in interacting with AUT. For example, the provider may emulate what a user may be providing via an input device, including, but not limited to, a keyboard, a mouse, a microphone, etc. The choice of provider may be determined by the association or binding of a provider to the active user interface element in the configuration file. Bindings, as described and used in this disclosure, refer to a connection of a form or document to a behavior or a control to a provider and optionally, at least one rule. Examples of bindings include, without limitations, a file open command, a file save command, a print command, or save command, etc.

A user may configure these bindings before execution of the application begins. If an element is encountered during execution that is not present in the bindings, tester 104 may automatically add a binding entry for the new element and associate it with a default Provider based on the new element's name or type. In some embodiments, step 204 may be skipped if the behavior recommends something other than regular input to the AUT. Tester 104 may choose to skip the active focus site, advance to another focus point, or proceed with other behavioral choices.

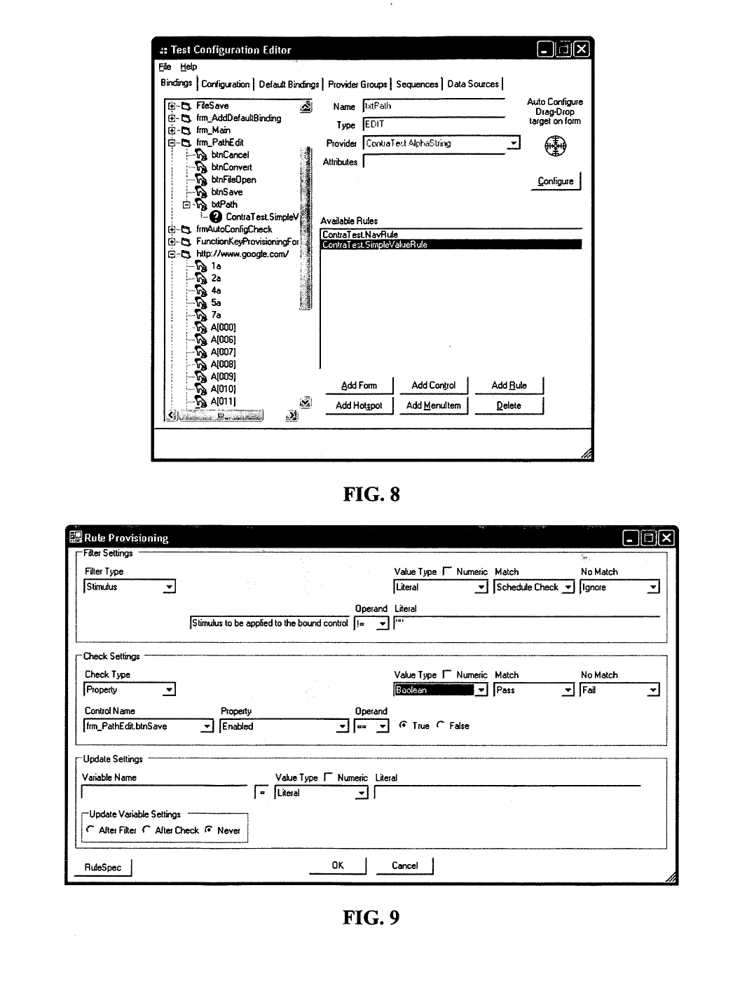

Once the stimulus is generated, a first verification stage (V1) may begin (step 206). In V1, tester 104 may evaluate rules (if any) associated with the focus site. A rule, as described and used in this disclosure, includes the expected state of the AUT before or after the stimulus is applied, the conditions under which that expectation is applicable, optional information to be remembered for future use by this rule or other testing elements, and the outcomes of matching or not matching the expected state of the AUT or the applicable conditions. In one embodiment, the rule may include a plurality of portions, as shown in FIG. 9. A first portion of the rule may verify the expected state of the AUT against the actual state of the AUT, generally referred to as the check. A rule may also include a portion that checks if conditions are applicable for performing the check, generally referred to as the filter. A rule may include a portion that may save information for later use and is generally referred to as the update. The filter part of the rule is evaluated in step 206 and results in a match or no match condition. If, for example, the match condition is set to “Schedule,” then the check part of the rule will be set to run after the stimulus is applied to the AUT, at the next second verification stage (step 212). If, for example, the match condition is set to “Immediate,” then the check part of the rule will be run immediately in step 026. The update part of the rule allows the tester to save a control value, the input stimulus, or other data and the stored data can be used in the filter or check sections of the same or other rules.

If the filter part of the rule indicated the check part should be evaluated then the check is evaluated in step 206 or 212 of FIG. 2. The check evaluates to a Match or No Match condition (shown in FIG. 9). If the actual application state matches the state specified in the check portion of the rule, the match outcome of the check may be recorded. The check outcome may be “Pass,” indicating the AUT is functioning as intended. If the actual and expected states don't match, the outcome may be “Fail,” indicating the AUT is not functioning as intended. The expected state may include the focus location, the value of a property of a control or form, or other value from the AUT, in any combination. In one embodiment, the check outcome includes additional outcomes for step 206, Verification Stage 1, including “Ignore,” indicating to a tester (e.g., tester 104 of FIG. 1) to not schedule the check part for later evaluation. An “Immediate” response indicates to the tester to perform the check in step 206, and “Error” results indicates an internal error occurred in the execution of the rule. The same outcomes, except for “Schedule” and “Immediate” may be returned by the check portion of the rule. The filter and check are evaluated to a Match or No Match condition and the outcomes of each condition may be separately specified. This allows rules to be specified in both a positive and negative sense. For example, pass if the AUT does something, or pass if the AUT doesn't do something.

As noted above, the outcome of each rule may include, but is not limited to, Pass, Fail, Schedule, Immediate, or Ignore. In some embodiments, this step may be skipped if the behavior recommends something other than regular input to the AUT. If the rule is based on only the current state of the application, then the V1 evaluation may result in Pass or Fail. If the rule is based on how the AUT responds to a stimulus, then the V1 evaluation may issue a Schedule to cause a second verification stage (V2) evaluation of the rule to occur after the stimulus is applied. If the stimulus makes the rule not applicable then the V1 evaluation results in an Ignore. A typical example of this situation is a rule for a button. If the button is not going to be activated by the stimulus then the V1 evaluation will result in Ignore. Referring to FIG. 3, an example rule that might be bound to the OK button is “If the OK button will be activated and the user name and password control values are valid then afterward the active form will be the main form.”

A stimulus may be applied (step 208), and the actions of the AUT after the stimulus application may be observed by tester 104. In one embodiment, tester 104 may determine the active form or document and which user interface element on that form or document will receive input from a keyboard, mouse, or other external sources. This information is called the focal site and is the basis for actions by the other steps of the main loop. Users can create custom observers by deriving from the Observer base class.

In step 212, a verification step 2 (V2) may be performed. Verification steps V1 and V2 can occur before and after the stimulus is applied, respectively. In particular, step 212 determines if the AUT responded as expected to the stimulus that was applied in step 208. The V2 evaluation can result in the outcomes Pass, Fail, or Ignore, but never Schedule. The Ignore outcome should be interpreted as meaning “not applicable.”

In step 214, a focus shifting process may be performed. In some embodiments, the focus site can be shifted for a variety of reasons, including, but not limited to, a random shift triggered by randomization or selection of an element that does not participate in the main tab sequence such as menus, toolbars, and graphical hotspots. These are referred to collectively as non-tab-sequence elements (NTSEs), which may have to be handled separately in the main loop because the normal way of advancing, may not cause NTSEs to receive the focus.

In some embodiments, step 214 may not be required. The frequency of occurrence may be dependent on the randomization probability and the non-tab element probability values read from the configuration. If both probabilities are 0 then no shifting will occur. If both types of shifts are triggered, the NTSE shift takes precedence. If a shift occurs, the application under test may follow the steps shown in FIG. 2, beginning with step 210.

In other embodiments, tester 104 may generate random focus shifts, which may emulate random user inputs from either a keyboard, mouse, tab sequence, or the likes. If a focus shift occurs it is accompanied by a new observation before proceeding to Behavior Modification.

The method steps of FIG. 2, particular steps 202, 204, 206, 208, 210, 212, and 214 may be repeated until the testing cycle limit is reached or other criteria, such as reaching a desired coverage level, are met. It is noted that not all the steps shown in FIG. 2 may be used. For example, in one cycle, step 212 may be omitted where in another cycle, step 214 may be omitted. One of ordinary skill in the art can understand that the steps illustrated in FIG. 2 are illustrative, and a combination of these steps or others may be used to test an application.

The behavior modification (step 202), stimulus generation (step 204), stimulus application (step 208), and verification (step 206 and/or step 212) may be executed code objects that are late bound in the execution process. The code objects for each are specified in testing configuration files that are read at startup and may be executed on a computer, such as processor 106 of FIG. 1. The objects are implemented in dynamic link libraries (DLLs) that may be specified in the configuration files and loaded at startup. By writing custom objects in custom user DLLs and referring to these objects in the testing configuration files, the custom objects may be loaded and used during testing in the same way as the standard object. Steps 202 through 214 are described in more detail below.

Creating a Testing Configuration

In one embodiment, the test configuration may provide a graphical user interface (GUI) similar to the GUI shown in FIG. 4, prior to execution of the steps shown in FIG. 2. Under a Project tab, a list of projects that may be configured is shown. A user may have the option to select which project (e.g., Editor and/or Logging) he or she may like to configure. In some embodiments, the GUI of FIG. 4 may be implemented in an add-in for a software development environment.

After the project is selected, a template for each selected project may be determined, as shown in FIG. 5. A template, as described and used in this disclosure, includes a set of configuration files containing a partial configuration intended as a starting point for a testing configuration process. The partial configuration may reduce the setup time of a test by providing a plurality of commonly used fields. As seen in FIG. 5, Editor is the selected project and a plurality of templates, including but not limited to Data Entry, Windows App, Web App, Accounting, etc. is provided to aid in the setup process of the testing configuration. The selection of the projects and corresponding template may be reviewed under the Overview tab and completed by selecting the OK button. When the OK button is activated, a tester (similar to tester 104 of FIG. 1) may scan the source code of the AUT for input elements and may add each input to the testing configuration and binds a behavior or provider to the element according to the element name and type, and the defaults specified in the configuration. Source code is not required to create a configuration as other means (e.g., scanning the document object model of an HTML application or using system calls to enumerate the windows in a window application) are included in an editor to discover input elements in an executing program and tester 104 will automatically add to the configuration elements discovered during test execution.

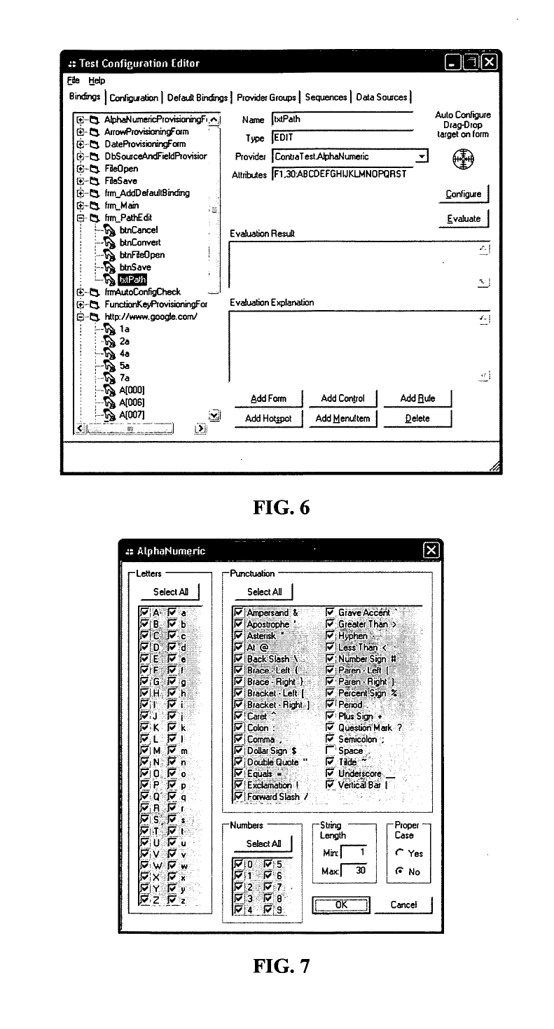

To configure a test for a particular project, a user may select an editor that may provide information about the bindings and provider groups among other information, as shown in FIG. 6. In one embodiment, the GUI of FIG. 6 may include, for example, default object listings such as “Bindings,” “Default Bindings,” “Configuration,” and “Provider Groups.” One of ordinary skill in the art may recognize other information may be provided to user to aid in the testing process. Similarly, there may be fewer objects provided to the user.

To create a provider binding with the GUI of FIG. 6, a user selects the control to be bound from the tree on the left and then the provider of choice from the provider drop down list. FIG. 6 shows the provider “ContraTest.AlphaNumeric” is bound to the control “txtPath” on form “frm_PathEdit.” To configure a provider, the user selects the “Configure” button, which exposes a configuration GUI, similar to the one shown in FIG. 7. For the “alphanumeric” provider, characters such as letters, numbers, and punctuations may be selected. A user may customize the providers by selecting deselecting the characters. Additionally, other configurations such as the “string length” of the characters or “proper case” of the characters may be determined. Different configuration GUIs may be appropriate for different providers. The user may also perform a trial evaluation of the selected provider, as configured, by selecting the “Evaluate” button shown in FIG. 6 and the results of the trial evaluation will be shown below the Evaluate button. Users can add providers and these providers can incorporate their own configuration GUIs.

Referring to the GUI illustrating the “Bindings” tab of FIG. 6, a list of different bindings is shown. As noted above, bindings may be used to provide a stimulus to a focus site (step 204). In one embodiment, the binding settings and the default binding settings are stored in a file that can be recalled when the testing of the software begins.

The GUI illustrated in FIG. 6 also includes an “Add Form” button which may allow a user to create a binding for a form anticipated to be created either at execution time or in the development environment. Similarly, the GUI illustrated in FIG. 6 includes a “Delete Form” button which allows a user to remove bindings for a form or document that may not be needed.

The GUI of FIG. 6 also includes “Add Control” button, which may enable a user to create a binding anticipated during execution and/or in the development environment. Similarly, a “Delete Control” button may be provided for bindings that may not be needed.

To create a rule binding with a GUI, similar to the one shown in FIG. 8, may be provided. A user selects the control to be bound, activates the “Add Rule” button, and then selects the rule from the list of rules. FIG. 8 shows rule “ContraTest.SimpleValueRule” is bound to control “txtPath” on form “frm_PathEdit.” A rule can be configured by activating the “Configure” button which exposes a configuration GUI similar to the one shown in FIG. 9. Different configuration GUIs may be appropriate for different rules. Using the GUI shown in FIG. 9, the user may set the filter, check, and update specifications. In the figure, the filter is set to match if the stimulus to be applied to the AUT is not an empty string. The filter match action is to schedule and the no match action is to ignore. The check is set to check that the control btnSave on frm_PathEdit is enabled. The check match action is Pass and the no match action is Fail. There is nothing specified to be saved in the update section.

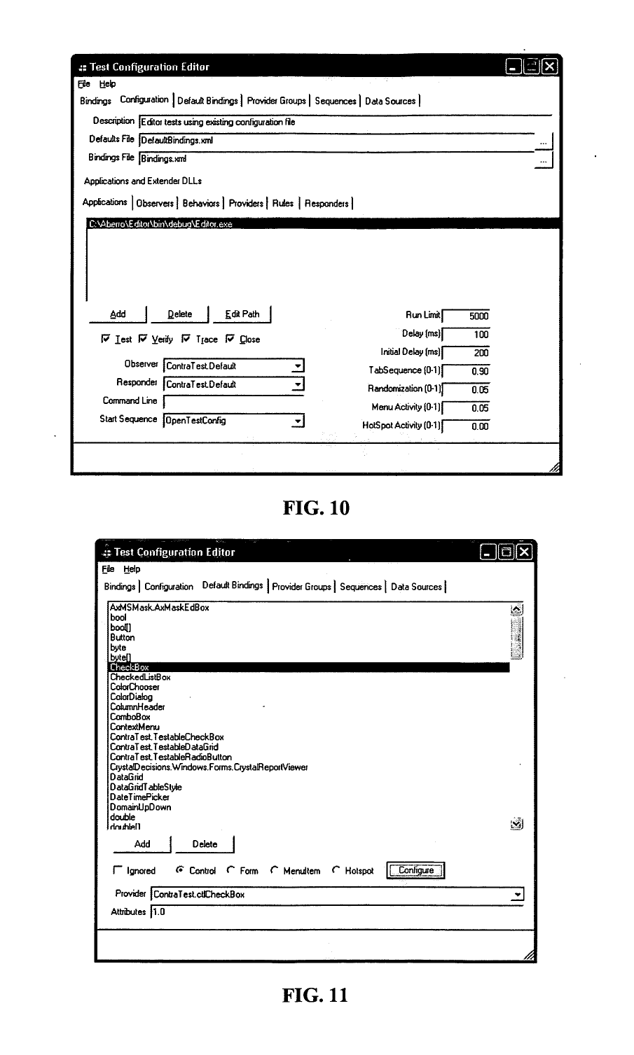

The GUI of FIG. 6 may also include a “Configuration” tab, which is provided in more detail by the GUI shown in FIG. 10. The Configuration tab may include a summary of the bindings used, a name of an editor, and the type of testing being performed. The configuration tab may also include an “Application and Extender DLLS” tab, which may be used to set file paths for different components, including, without limitation, the behaviors, the providers, the rules, etc. and may each contain a list box for maintaining a list of type-specific DLL files. Each of these items may be added and or deleted based on a test strategy.

The “Default Bindings” tab of the GUI shown in FIG. 6 and further detailed in the GUI of FIG. 11 includes a list of possible behaviors associated with a form or document which may be stored in a file that can be recalled when a user selects the Default Binding tab. The Default Bindings may be used to provide an initial binding for newly discovered elements. A user can override the default and change a binding as desired. Generally, the default bindings provide a starting point and a user may refine the bindings to provide a more useful interaction with an AUT during testing. In one embodiment, a user may select ADD or DELETE a binding from the list using the ADD or DELETE button displayed on the GUI shown in FIG. 11. Similarly, a user may select to ignore particular bindings when executing a test by selecting a particular binding and selecting the “Ignored” field.

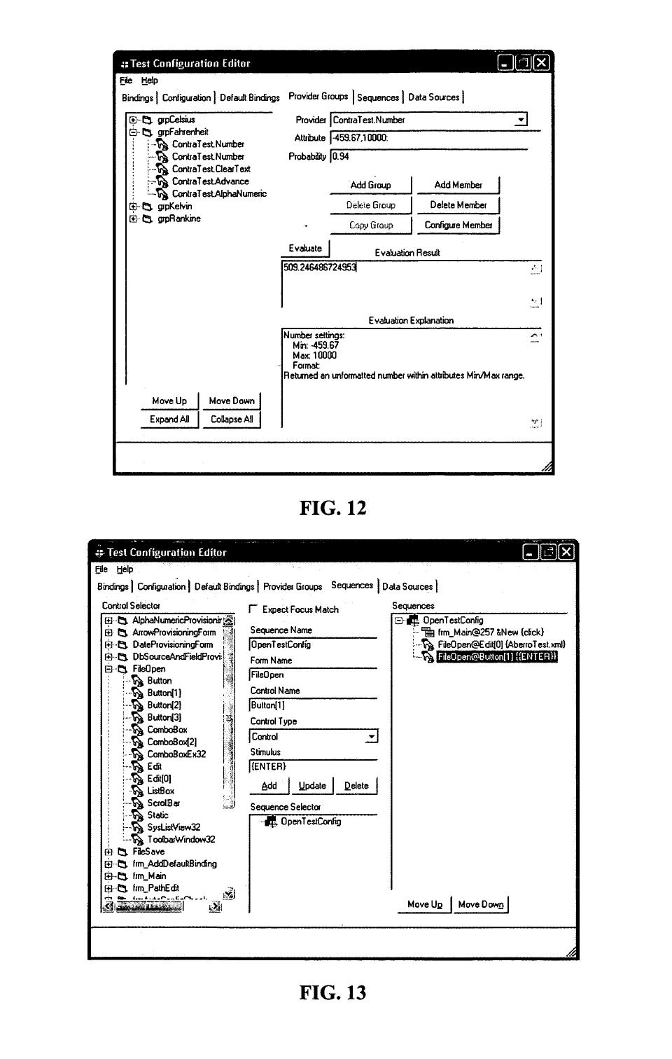

The “Provider Groups” tab of the GUI shown in FIG. 6 and shown in more detail in FIG. 12 organizes the multiple provider members. As noted above, a provider is an object that generates a stimulus for use in interacting with the AUT (step 204). As such, in one embodiment, the providers may be implemented in DLLs, which can be loaded at runtime and executed by a tester (e.g., tester 104 of FIG. 1) to use with the AUT specified in the configuration. A Provider Group is a type of compound provider which may contain multiple members, each of which is a provider or group specification. Groups are named and may be specified as either alternative or composition. In an alternative group, only one of the members is chosen and evaluated each time the group is evaluated (e.g., step 204). The choice may be random, according to relative probability associated with each member. In contrast, when a composition group is evaluated, every member is evaluated and the results are concatenated in the order the members are specified in the group. The GUI provides a plurality of buttons which can organize (“Add Group,” “Delete Group,” “Copy Group,” etc.) the providers based on the test strategy. A provider group may be used anywhere a provider may be used, including as a member of another group.

The GUI of FIG. 6 also contains a Sequence tab which is shown in more detail in FIG. 13. The GUI may allow a user to compose, edit, and delete sequences of focal points and the stimulus to be applied to each focal point. The left tree in FIG. 13 shows the available forms and controls while the right tree shows the sequences. In one embodiment, sequences are named and can be used as building blocks to create larger sequences. A sequence can be designated as the start sequence which causes the designated sequence to execute at the beginning of testing. Sequences can also be bound to controls by using a sequence provider and such sequences execute when the bound control receives focus. These sequences are used to force the AUT to reach a desired state. Using these sequences causes the tester to operate as a more traditional tester by attempting to force the AUT to reach a desired state through an externally provided, potentially unnatural sequence of inputs, rather than achieve the desired state by following the natural input sequence provided by the AUT.

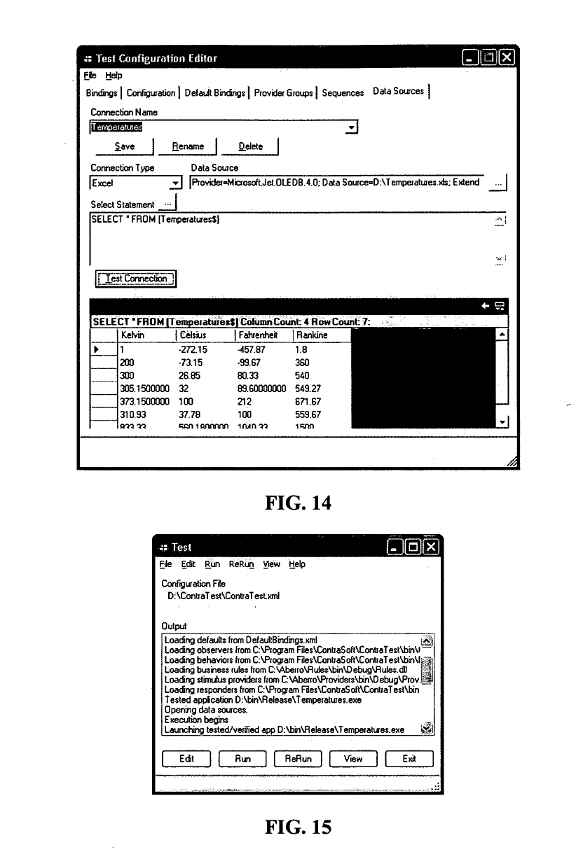

The GUI of FIG. 6 also contains a Data Sources tab which is shown in more detail in FIG. 14. Using the GUI of FIG. 14, a user may create, edit, and delete settings which control the selection and retrieval of data from external sources, including spreadsheet files, comma separated value files, different types of databases, and the like. The user may name the settings where the name may be used with providers to retrieve data from the external source. In one embodiment, the data source setting is a connection string as used in a open database connectivity (ODBC) or structured query language (SQL) server connection object. The Select Statement is a SQL select statement and controls what is retrieved from the external source. The GUI of FIG. 14 also contains a Test Connection button that allows a user to try the connection settings and view data retrieved from the external source using these settings.

Executing and Verifying the Test

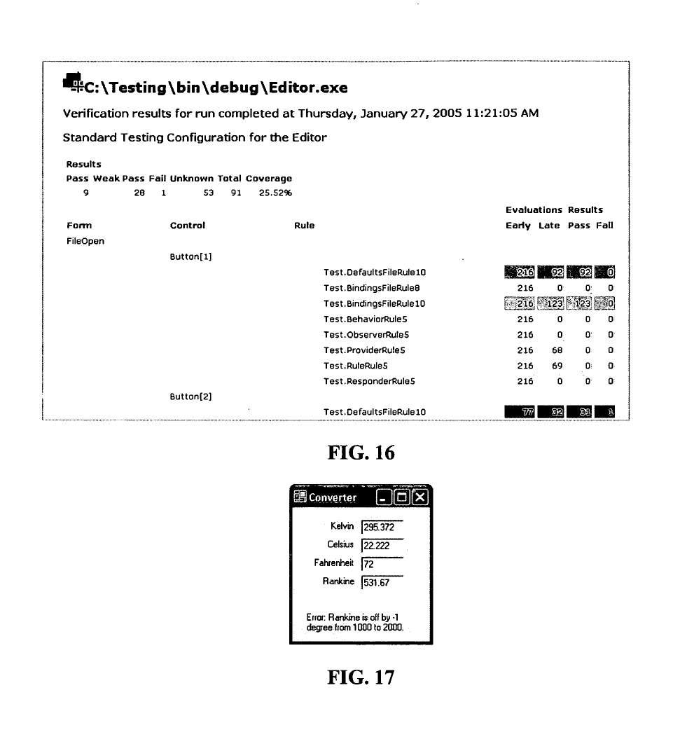

Upon configuring the test parameters, an application may be tested. Referring to FIG. 15, a test execution GUI is presented which summarizes the details of the test. For example, the current working directory, descriptions of the run (limit, delay, etc.), the path for the application being tested, among other information are shown. Activating the Run button causes testing to start and the test may be executed similar to the steps shown in FIG. 2 and may yield verification reports similar to the table shown in FIG. 16. In one embodiment, the verification reports may display, among other information, a summary of the pass and failed responses of the AUT (e.g., steps 206 and/or step 212 of FIG. 2). Other buttons on the GUI permit editing the test configuration using the GUIs of FIGS. 6 through 14, rerunning a previous test, and viewing the execution logs and reports.

It is noted that the verification steps may be used to confirm that the AUT meets a predetermined specification. In one embodiment, the verification steps may continuously be evaluated (comparing the actual behavior against the expected behavior) during the execution of the AUT. While the verification steps may not prove definitively that an AUT has met the predetermined specification, it may provide a probability.

In one embodiment, the verification steps may be performed independent of the testing of the application. In particular, a tester 104 may be provided that omits steps 202, 204, 208 and 214 but implements steps 206, 210, and 212 to track the execution of the AUT and compare the expected response to the actual response. Such a tester would not actively interact with the AUT but would passively observe and check the behavior of the AUT. Such a tester could be used to check the behavior of the AUT while the AUT is driven by other means such as users using the AUT in production use.

Description of the Implementation

The testing environment can be implemented using, for example, Microsoft Visual Studio .Net 2003 development environment, .Net Version 1.1 framework, and C# and C++ languages. The testing environment can be designed to run under the Microsoft Windows XP operating system, provide GUIs, and to test applications that run under Microsoft Windows XP and Microsoft Internet Explorer 6. One of ordinary skill in the art can realize that other platforms and browsers may be used.

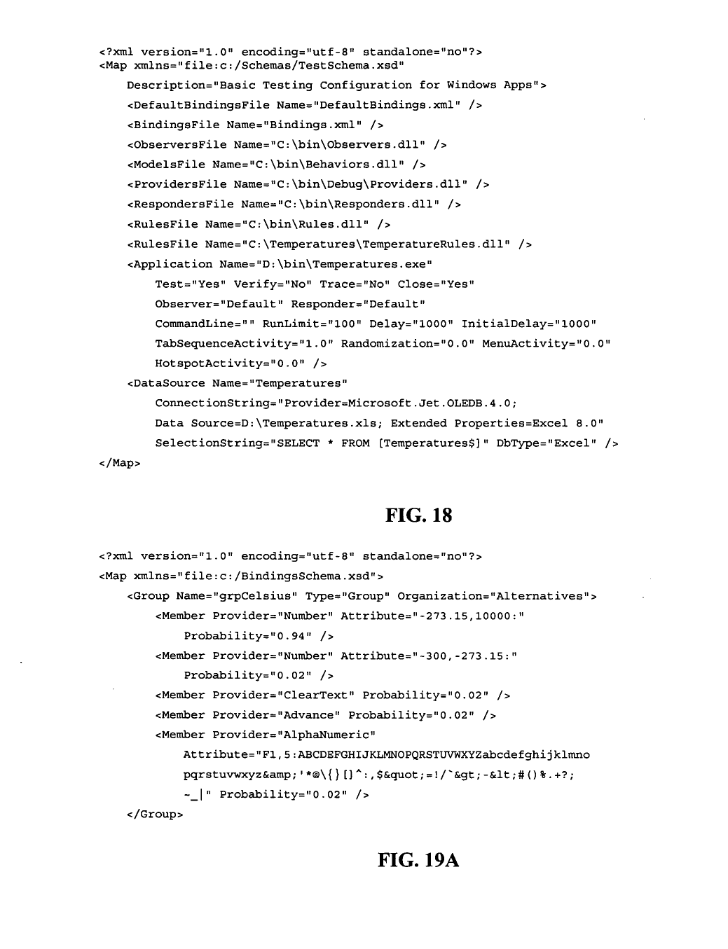

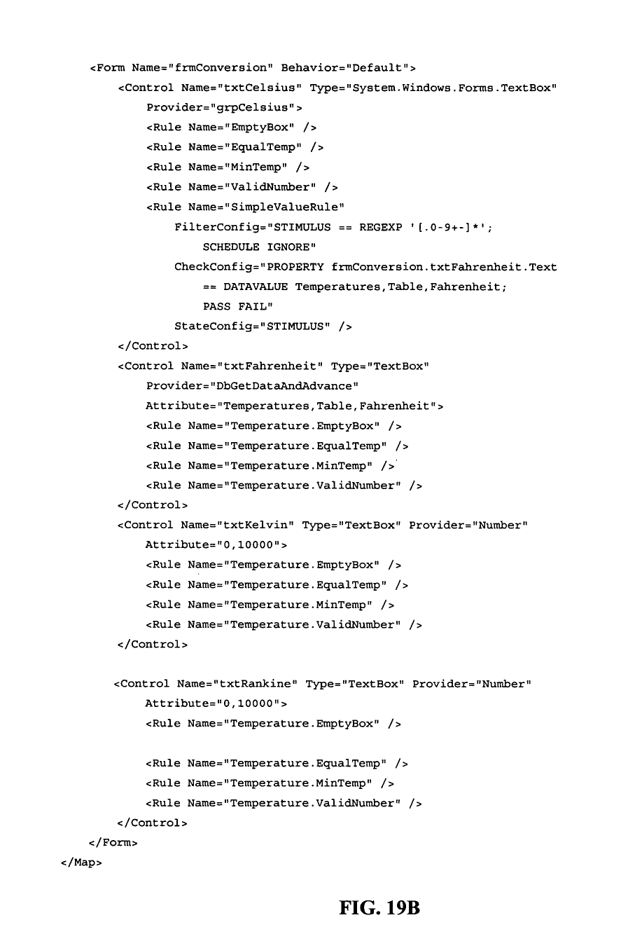

FIG. 17 shows a simple application program that converts a temperature value from one scale to three other scales. The user may enter a number in any text box and the corresponding temperatures will appear in all the others. The text box controls the user may enter temperature values into are named, txtKelvin, txtCelsius, txtFahrenheit, and txtRankine respectively. As noted in the figure, this application has an intentional bug. The application of FIG. 17 is the AUT for the main configuration file of FIG. 18 and the bindings file of FIG. 19.

The Test Configuration Files

The test configuration files contain text, structured as XML, that tester 104 can use for initialization and testing of the AUT. There are three configuration files, referred to as the main configuration file, the bindings file, and the defaults file. The configuration file specifies the other two configuration files, the applications that will be tested, data connections, various test run parameters, the DLLs that will be used during testing for providers, rules, behaviors, and the like. An example main configuration file is shown in FIG. 18.

In one embodiment, DLL file names are specified for observers, behaviors, rules, providers, and responders. There may be at least one DLL file for each and there may be multiple entries of each type. In one embodiment, referring to FIG. 18, there are two RulesFile specifications. The first specifies the standard rules file, rules.dll, and the second specifies a user-written custom rules file, TemperatureRules.dll. FIG. 18 also includes specifying the AUT shown in FIG. 17, Temperatures.exe. The path to the AUT executable is specified along with parameters that indicate:

1. If the AUT is tested or just launched (Test);

2. If rules are evaluated (Verify);

3. If screen pictures are taken at each step (Trace),

4. If the AUT is closed or left open at the end of testing (Close);

5. Which observer will be used with the AUT (Observer);

6. Which responder will be used with the AUT (Responder);

7. The command line arguments to set for the AUT when starting the AUT (CommandLine);

8. The number of test cycles to perform before terminating testing (RunLimit);

9. The delay in milliseconds between each test cycle (Delay);

10. The delay in milliseconds between starting the AUT and starting testing (InitialDelay); and

11. The relative probabilities for following the AUT tab sequence (TabSequenceActivity), random focus changes (Randomization), selecting menu items (MenuActivity), and selecting a graphical area (HotspotActivity).

The main configuration may contain 1 or more application specifications

Next, a data source specification is specified, which defines a type, connection string, and selection statement for use in creating a data set for the providers and rules during testing. FIG. 18 shows the connection string and selection statement to connect to, for example, a Microsoft Excel spreadsheet and retrieves data from the worksheet named Temperatures, using an OleDb connection, data adapter, and dataset.

FIGS. 19A and 19B show the contents of an example bindings file. The behavior, provider, and rule names which appear in the bindings specification correspond to the names of executable objects in the providers, rules, and behaviors DLLs. The name given in the specification is used to locate the corresponding object in the DLL so that the specified operation can be performed as needed by tester 104.

In general, the bindings file contains the connections between AUT elements and testing specifications. The file may contain a plurality of group specifications. A group specification includes a plurality stimulus provider specifications and may be an alternative or composition group. The result of evaluating an alternative group is the result of evaluating one member chosen at random, based on the relative probabilities specified for each member. The result of evaluating a composition group is the concatenation of the results of evaluating each member in the order the members appear in the group. The group named grpCelsius in FIG. 19B is an alternative group and is intended to produce a valid Celsius value 94% of the time, an invalid Celsius value 2% of the time, clear the field 2% of the time, skip the field 2% of the time, and attempt to enter invalid number characters 2% of the time. FIG. 19B shows that grpCelsius is used as the provider for control txtCelsius.

The bindings file may also contain zero or more form specifications. A form represents an object that may contain multiple interaction elements. FIG. 19B contains a form specification for frmConversion, the form shown in FIG. 17. This form contains specifications for the 4 text box controls txtKelvin, txtCelsius, txtFahreneheit, and txtRankine which appear on the form in FIG. 17. Each control contains a provider and attribute specification that specify how the tester should produce stimuli for the control and may also contain zero or more rule specifications that specify when and what behavior the tester should expect when interacting with this control in the AUT. (If there are no rules bound to a control then no checking is done when that control receives focus.) In FIGS. 19A and 19B, the control, txtCelsius will receive stimuli generated by evaluating grpCelsius, the control txtFahrenheit will receive stimulus generated by evaluating the provider DbGetDataAndAdvance, which retrieves a value from the current row for field Fahrenheit from a table, Table in the data source named Temperatures, which is specified in the main configuration file. The data source name, table name, and field name are specified in the attribute named Attribute. The provider DbGetDataAndAdvance automatically advances to the next row of the table after retrieving a value. The controls txtKelvin and txtRankine both will receive stimuli generated by the provider Number, and their attribute specification customizes the stimuli generated by Number to values which are within the range of valid Kelvin and Rankine numbers, respectively.

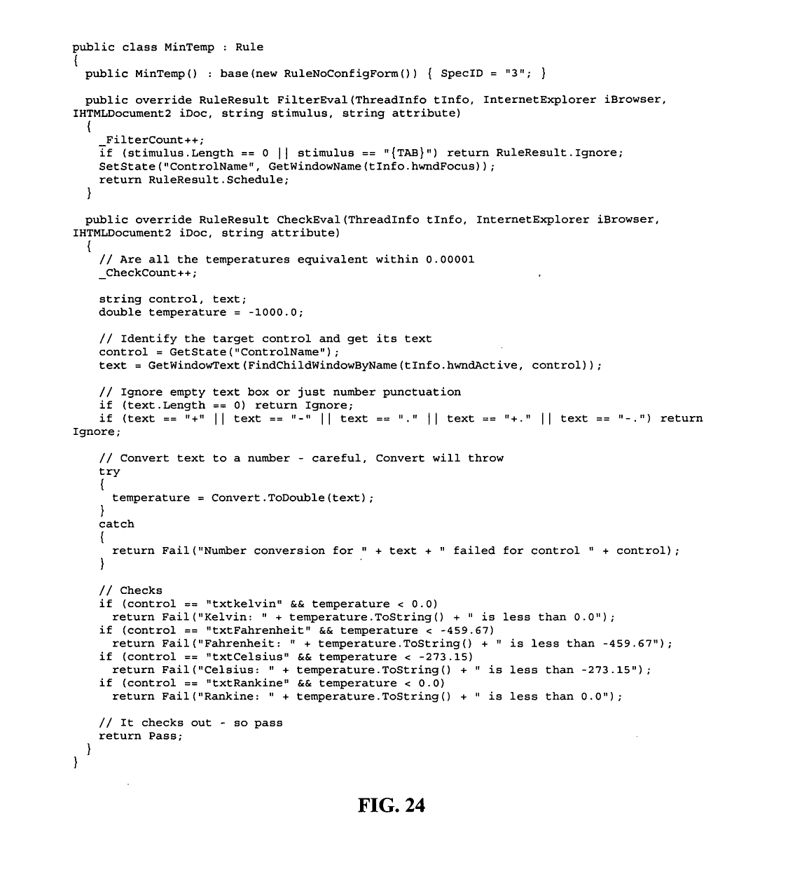

The controls in FIGS. 19A and 19B also contain rule specifications. Control txtCelsius contains a specification for rule SimpleValueRule. This rule is one of the standard rules and permits the user to filter and check behavior against a variety of values, including the stimulus, a property of a control, a value from a database, a regular expression, or the like. This rule is configured with the GUI shown in FIG. 9. The FilterConfig part of the rule specifies that the check part of the rule will be scheduled if the stimulus matches the regular expression, which in the example includes 0 or more digits, decimal point, and + or −. If the regular expression is not matched, the check will not be scheduled. The CheckConfig part of the rule specifies that if the check is evaluated, the text property of txtFahreneheit matches the data value retrieved from the specified source, table, and field, then the rule results in a Pass, otherwise the rule results in a Fail. This rule makes sure that when a numeric value is entered into txtCelsius, the value in txtFahrenheit contains the equivalent temperature value. There are 4 other rules bound to txtCelsius which check different behaviors. In particular, the MinTemp rule checks to see that no temperature value is below the physical minimum for each scale. The MinTemp rule is implemented as a user written rule and the source code for this rule is shown in FIG. 24.

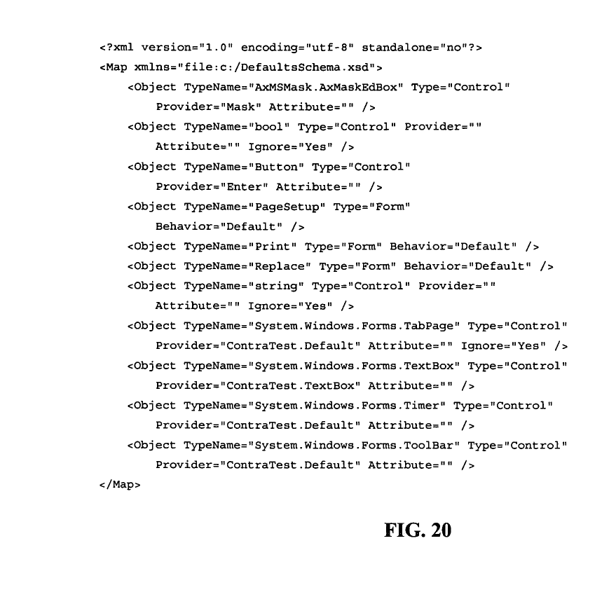

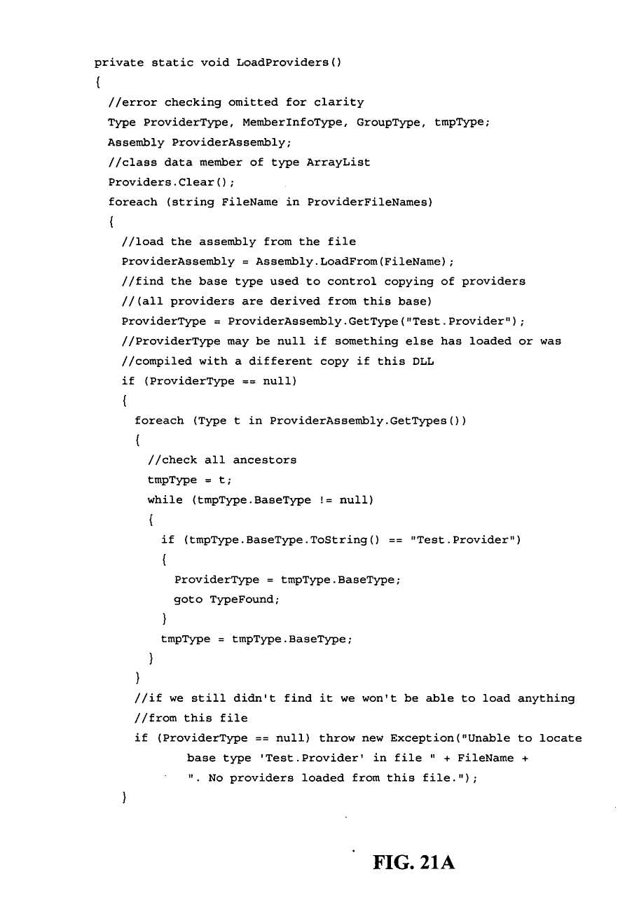

Referring to FIG. 20, an example of a default bindings file is shown. In one embodiment, the user may create bindings manually or allow tester 104 to create them automatically. The default bindings file contains specifications for zero or more defaults, where each default may specify the element type, name, behavior to use, provider to use, attribute setting for the provider, and if matching elements should be persisted in the bindings file or are ignored (e.g., not written to the bindings file). When tester 104 discovers an element in the AUT not already in the bindings, tester 104 may search for a default whose TypeName and Type properties matches the element's instance name and type. If no match is found, tester 104 may search for a default whose TypeName and Type properties match the element's type (textbox, combobox, list, button, etc). If a match is found, tester 104 may create a new binding using the provider and attribute specifications from the matching default entry. If the AUT element is a form, the provider property from the default may be used as the value for the behavior property in the binding.

If no match is found, tester 104 may set the behavior or provider property in the binding to a fixed value “Default.” The Default behavior is designed to work with most forms and the Default provider echoes the attribute setting. If the user leaves the Default provider's attribute blank, the Default provider will effectively do nothing. Tester 104 may also compare both TypeName and Type in the default specifications so that a value for TypeName can appear more than once, but the combination of TypeName and Type must be unique. This permits specifying different defaults for the same name when used as different types of elements. For example, a DataGrid may appear as both type Form and type Control. This is useful because tester 104 may map a DataGrid as a form under some circumstances and as a control under others.

Initialization for Test Execution

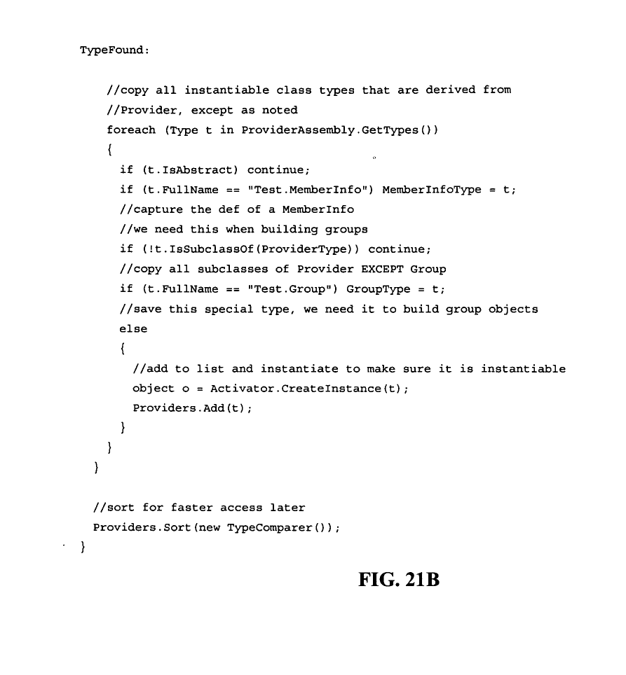

Initialization begins by reading the configuration files (e.g., FIGS. 18, 19A, 19B, and 20) and creating the contents of the configuration files in memory data structures. Next, the DLLs specified in the main configuration file are loaded and scanned for objects derived from the appropriate base classes. A type object or instance is created for each matching object and added to an array for name lookup and later use during test execution. Example code for loading a DLL, scanning it, and creating an array of provider types are shown in FIGS. 21A and 21B.

Referring to FIGS. 21A and 21B, an array of provider type objects may be built. For each provider and DLL file in the file names list, tester 104 may load the assembly contained in the DLL and then scans through the assembly. Before scanning, tester 104 may retrieve a type object corresponding to the provider base class. If that fails, tester 104 may scan for a type whose name matches the base class type, and use the type with the matching name as the base type.

Once the base class type is found, the base type may be used to select all objects in the assembly that are derived from the base class. An exception is made for type Group because group evaluations are handled differently than other providers. Each type object that meets the selection criteria is instantiated to make sure the object can be instantiated when needed during test execution. The type object may be added to the array of provider objects. The load method shown may create an array of provider instances instead of type objects if desired and the choice is based on whether a single instance or multiple instances of a given provider type are needed in tester 104. The loading of the other late bound types is handled similarly.

The Test Execution Cycle

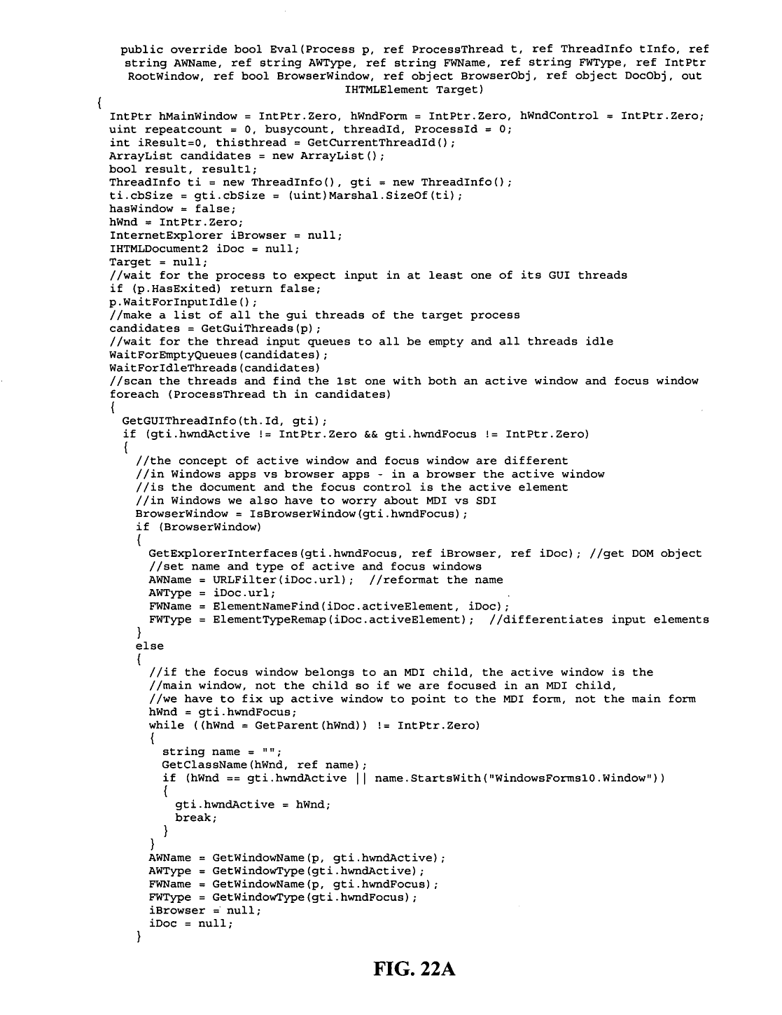

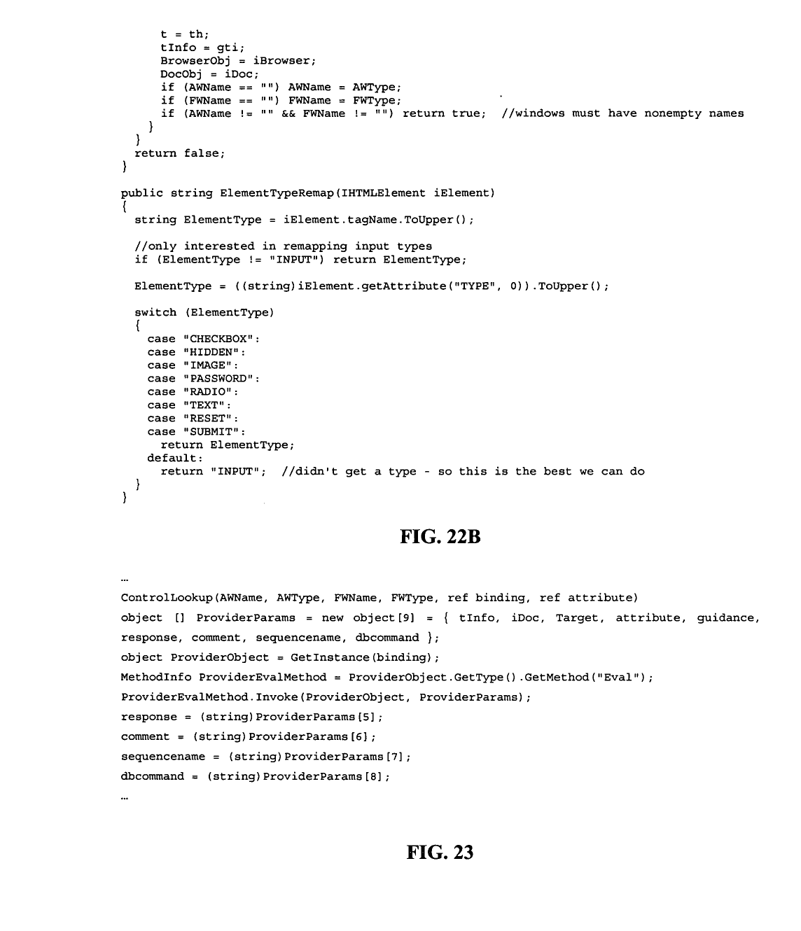

Once initialization is complete, the applications are started and testing begins. The first step in a test cycle is to execute an observer and determine the interaction element in the AUT, and when necessary, perform a remapping to make the active focus site names and types more useful in testing. FIGS. 22A and 22B show an example observer function and an input remap function. Error checking has been omitted for clarity.

The observer function is named Eval and takes as input a process object. The observer may wait for the process to finish any pending processing and then determines the threads in the process that contain an input queue. From those threads, the observer may find one that has an active focus site. The observer may determine if the focus site is an element within a browser window and if so, retrieves the document object model (DOM) for the document associated with the browser window and sets the name and type of the active and focus sites from elements within the DOM.

FIGS. 22A and 22B also show that a HTML element, Input, which may be remapped to more specific types. In FIGS. 22A and 22B, the observer determines if the focus site is a multiple document interface (MDI) child, and if so, the observer remaps the active window from the MDI child window form to the parent window, which is usually the main application window. Application behavior may vary the implementation methodology and testing goals and thus, different observers may be required to identify and remap the active focus site names and types. The need for a different observer is quickly identified in testing when the observer in use provides names and types that are confusing to the user or are not useful in testing. Creating a new and more useful observer in these circumstances depends on the AUT and therefore, may require a trial an error process.

The observer may return, among other information, a thread information structure containing the active and focus site handles, the remapped names and types of the active and focus sites, the browser and DOM objects, the active element in the DOM, and a flag indicating the focus site is an element in a browser window. If the focus site is not in a browser window, then the DOM and browser related return values are not useful.

After the observer concludes, tester 104 determines if the focus site should shift as a random jump event or because, for example, the focus site has failed to advance from one element to another. If a focus shift occurs, the name and type of the active focus site are changed.

Next, tester 104 may execute verification stage 2 (step 212) and may execute any checks that were scheduled in the prior verification stage 1 step (step 206). Tester 104 may evaluate the behavior object associated with the active window. The behavior object can alter the focus site setting to achieve a more tester-useful value. The choice of altering the focus setting is very specific to the type of the active window. For example, the natural sequence of a file open dialog starts in the file name text box, advances to the filter selection combo box, and then to the open button. This may not be desirable for testing because testing may be more effective if the filter selection is left unchanged. So the behavior may, through intentional focus shifting, implement a virtual sequence that flows from the file name text box to the open button, to the file selection list, and then to the filter selection combo box. The behavior object may also be used to check for cycles in focus sequencing and shift focus to break a cycle.

After the behavior is evaluated, the provider for the focus site may be retrieved and evaluated. FIG. 23 shows an example code fragment for performing a provider lookup and execution based on the focus site name and type. Error checking is omitted for clarity.

The ControlLookup function retrieves the name and attributes for the provider bound to the active control. The names and types of the active focus site are passed to the ControlLookup function in and the name and attribute of the bound provider are returned. Next, the returned provider name is used to retrieve an executable instance of the provider with the same name by calling the GetInstance function with the name of the provider. GetInstance returns an executable instance of the provider object with the corresponding name. Next, the Eval method object is retrieved from the provider instance using the GetMethod function. Arguments for the Eval method are copied into an object array named ProviderParams and the Eval method is executed by calling Invoke and passing it the provider instance object and the parameters. The Eval method returns values in the parameters array and the code fragment shows retrieving values from the parameter array The response return value is text or a command like .Net SendKeys.Send method accepts to be sent to the AUT. The comment text, if any is sent to the log. The purpose of the comment is to provide a way for the provider to give the user an explanation for how it chose to generate the response. The sequencename parameter is the returned name, if any, of a test sequence. If a sequence name is present, tester 104 will follow this sequence of steps like a traditional script or table based tester. The dbcommand parameter if present causes data source actions like advance to next row or reset row number to occur after checking, if any occurs. The delay in executing the command permits the checking to use the same row in a data table as the provider used. The lookup, instantiation, and execution techniques of FIG. 23 may be used for other late bound objects, including Rules, Observers, Behaviors, and Responders.

After the provider formulates a stimulus for the AUT, if there are any rules bound to the focus site, the corresponding rule objects may be retrieved and the verification stage 1 method from the rule objects will be executed. The results of these executions are logged and if any result indicates a verification stage 2 evaluation should occur, the rule is added to the list of rules to be executed at the verification stage 2 step of the testing cycle.

In the final step of the testing cycle, tester 104 may execute a Responder to transmit the stimulus to the AUT. One Responder available to tester 104 may retrieve the stimulus string of text and commands and may convert the string into an array of structures appropriate for the SendInput Windows API function and then calls SendInput to transmit the stimulus to the AUT.

FIG. 24 shows the implementation of the MinTemp rule. Note that the constructor passes an instance of a configuration form to the base constructor. A constructor, as defined and used in this disclosure is a function defined in the MinTemp class which executes when an object of the class is instantiated. This rule does not require any configuration but for example, the form shown in FIG. 9 is passed as the argument to the base constructor for the SimpleValueRule. The base class provides a method used by the editor to display the form and set configuration information. The MinTemp class shown in FIG. 24 contains the methods FilterEval and CheckEval. The method FilterEval is used in step 206 to perform the filtering part of the rule evaluation. The method CheckEval is used in step 212 (or possibly step 206 if the filter specifies an immediate evaluation). The arguments to both the FilterEval and CheckEval methods include a system ThreadInfo structure that contains the active and focus site handles. The arguments also include references to the browser object and DOM object, which are 0 if the active and focus site are native windows and not browser windows. The arguments also include an attribute string which may contain configuration information for use by the FilterEval and CheckEval functions. For example, the information specified on the form shown in FIG. 9 is passed to the FilterEval and CheckEval functions of SimpleValueRule so they can perform the desired filtering and checking actions. The contents and format of the attribute string is specific to each rule. The FilterEval method has an additional parameter, the stimulus to be applied to the AUT in step 208, which it may use to determine the outcome of the filter. The FilterEval in FIG. 24 may schedule a check unless the stimulus is empty or is a tab command. The FilterEval also retrieves the name of the focus site and saves it in a hash table under the key “ControlName” by calling the function SetState. This value will be used in the check part of the rule to identify which of the 4 text boxes of FIG. 17 needs to be checked. The filter does this because at the time the check is performed in step 212 the stimulus has been applied in step 208 and the AUT may have shifted focus. The update part of the SimpleValueRule which may be configured with the GUI shown in FIG. 9 is implemented using the SetState function.

The CheckEval method retrieves the saved control name and uses it to retrieve a window handle to the control. It then uses this handle to retrieve the value of the control. Next, a check for control values that should be ignored because they do not represent a numeric value is determined. The value is converted to a number and compared against the known physical minimum value.

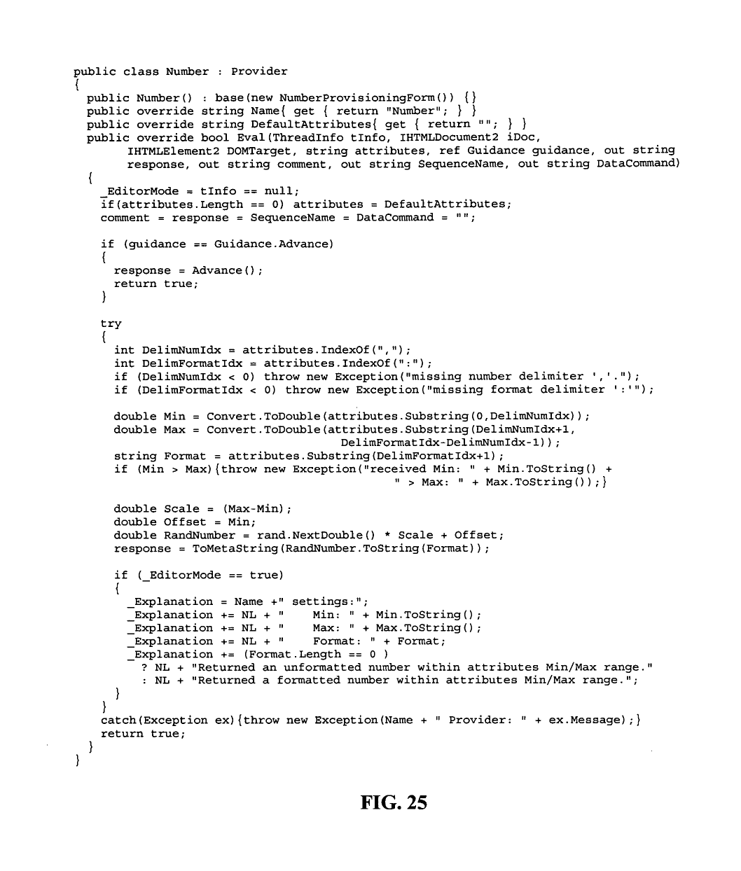

FIG. 25 shows the implementation for a provider that generates numbers. The constructor passes the base constructor a configuration form instance. The configuration form is displayed by a base class method used by the editor and is used to set the value of the attribute sting that is passed to the Eval method. The Name method returns a name string, which is generally the same as the provider class name, but may be different. Lookup by the GetInstance function used in FIG. 23 uses the value returned by the Name method to match to the name used in the binding specification. The Eval method performs the stimulus generation and is the provider method invoked in step 204. The ThreadInfo structure, the browser object, DOM object, DOM target, attribute string, and guidance value are passed to the Eval method. The browser and DOM objects will be null if the AUT is not running in a browser window. The guidance value indicates what type of stimulus the Eval method should generate. The value “Advance” means generate a stimulus that will advance focus to the next control. Most controls advance on a tab command, but control-specific providers may return whatever stimulus will cause focus to advance.

The attribute string for the Number provider shown in FIG. 25 must contain a minimum value and a maximum value separated by a comma and followed by a colon. The colon may be followed by an optional format specifier. If present the format specifier will be used to format the returned number. The min, max, and format parts are parsed from the attribute string. The min and max are used to set the bounds for generating a random number. The generated number is formatted according to the format specification and then any characters that have special meaning in the SendKeys syntax are escaped in the function ToMetaString. The resulting stimulus is returned via the response parameter.

Other providers use the SequenceName parameter to return the name of a sequence. If a sequence name is returned, tester 104 will operate like a traditional script or table-based tester and follow the sequence. The DataCommand parameter is used by providers that use data sources which may be configured using the GUI shown in FIG. 14. The DataCommand parameter is used to cause the data source to advance to the next row of data or reset to the first row of data. Tester 104 delays applying the data command until just after step 212 so that rules may use the same row of data used by providers.

All of the methods and systems disclosed and claimed can be made and executed without undue experimentation in light of the present disclosure. While the methods of this invention have been described in terms of embodiments, it will be apparent to those of skill in the art that variations may be applied to the methods and in the steps or in the sequence of steps of the method described herein without departing from the concept, spirit and scope of the invention. All such similar substitutes and modifications apparent to those skilled in the art are deemed to be within the spirit, scope, and concept of the disclosure as defined by the appended claims.

1. A method for testing a software application, comprising:
providing a tester for testing the software application, where testing comprises:
monitoring the software application during natural execution to determine an active focus site of the software application;
generating a stimulus for the active focus site based on a current execution state of the application;
applying the stimulus to the active focus site; and
monitoring a response of the application to the stimulus.

2. The method of claim 1, further comprising evaluating a rule associated with the active focus site prior to the step of applying the stimulus.

3. The method of claim 2, the rule comprising a filter portion and a check portion.

4. The method of claim 2, the rule comprising an expected result from the software application after the stimulus is applied.

5. The method of claim 2, where a result of the step of evaluating a rule comprises Pass, Fail, Schedule, Immediate, or Ignore.

6. The method of claim 5, where if the result of evaluating the rule is Schedule, the method further comprises evaluating the rule after the step of monitoring the response to the application.

7. The method of claim 5, where if the result of evaluating the rule is Immediate, the method further comprises evaluating the rule prior to applying the stimulus to the active site.

8. The method of claim 1, further comprising determining a next active focus site.

9. The method of claim 8, where the next focus site occurs naturally in the application after the active focus site.

10. The method of claim 8, where the next focus site is selected randomly.

11. A program storage device readable by a machine, tangibly embodying a program of instructions executable by the machine to perform the method steps of claim 1.

12. A method for evaluating a software application test, comprising:
providing a tester for testing the software application, where testing comprises:
performing a first verification step to determine if a stimulus to be provided to an active focus site of the application would be valid;
providing the stimulus to the active focus site of the application; and
performing a second verification step to determine if the application responds correctly to the stimulus, where the first and second verification steps are distinct from the step of providing the stimulus.

13. The method of claim 12, where performing a first verification step comprises evaluating at least one rule associated with the active focus site.

14. The method of claim 13, where the at least one rule is associated with a current state of the software application.

15. The method of claim 12, where a result of the first verification step includes Pass, Fail, Schedule, Immediate, or Ignore.

16. The method of claim 15, where if the result of the first verification step is Immediate, performing the second verification step after the first verification step.

17. The method of claim 12, where a result of the second verification step includes Pass or Fail.

18. A method for testing a software application, comprising:
providing a tester for testing the software application, where testing comprises:
monitoring the software application during natural execution to determine an active focus site of the software application;
performing a first verification step to determine if a stimulus to be provided to an active focus site of the application would be valid
generating the stimulus for the active focus site based on a current execution state of the application;
applying the stimulus to the active focus site; and
performing a second verification step to determine if the application responds correctly to the stimulus, where the first and second verification steps are distinct from the step of providing the stimulus;
